(19) United States
(12) Patent Application Publication
(10) Pub. No.: US 2013/0119258 A1
(43) Pub. Date: May 16, 2013

(54) METHOD AND APPARATUS FOR THE DETECTION OF X-RAY QUANTS

(71) Applicants: Reiner Franz Schulz, Erlangen (DE); Kaiss Shanneik, Erlangen (DE)

(72) Inventors: Reiner Franz Schulz, Erlangen (DE); Kaiss Shanneik, Erlangen (DE)

(21) Appl. No.: 13/467,417

(22) Filed: May 9, 2012

(30) Foreign Application Priority Data
May 9, 2011 (DE) 10 2011 075 520.9

(51) Int. Cl. G01T 1/20

(52) U.S. Cl. CPC G01T 1/2006
USPC 250/362; 250/394

(57) ABSTRACT

A method for the detection of X-ray quants is provided. The X-ray quants are generated in an X-ray tube and impact on a multi-pixel X-ray detector including a two-dimensional matrix of test-signal-generating pixels. The method includes assigning, by an evaluation unit, pixels that generate a test signal within a predetermined time interval and are located in a cohesive cluster including a plurality of pixels to an event cluster. The test signals are used to approximate a position, at which the X-ray quant has interacted with the multi-pixel X-ray detector.

This application claims the benefit of DE 10 2011 075 520.9, filed on May 9, 2011.

### BACKGROUND

The present embodiments relate to a method and an apparatus for the detection of X-ray quants.

X-ray radiation is used in a very wide range of applications (e.g., medicine) to study the structure and/or the composition of objects. In addition to a suitable X-ray source (e.g., an X-ray tube), an X-ray detector is provided to detect the impinging X-ray radiation.

Electronic detectors may be used as X-ray detectors (e.g., for image-generating detection of X-ray radiation). Test signals from the electronic detectors are recorded by readout electronics and may be digitized.

Detectors, in which the X-ray radiation is used in a scintillator to generate photons that have a wavelength in the visible light range, may be used. The photons are recorded by a matrix of light-sensitive semi-conductor sensors (e.g., CCD-sensors) and converted into an electronic test signal. A disadvantage of this type of detection is that the parameters of contrast resolution and spatial resolution that are essential for image detection may not be optimized independently of each other.

For a good contrast resolution, as few X-ray quants as possible are to pass through the scintillator without interacting with the scintillator. Since the probability of absorption increases as the material expands, a thickness that is as large as possible may be selected for the scintillator. The light generated in the scintillator spreads out in all directions, however. The result thereof is that the distribution of the photons that an X-ray quant has generated becomes wider in the contact surface zone between the scintillator and the sensor matrix, as the thickness of the scintillator increases. This leads to a reduction in the spatial resolution. The width of the photon distribution decreases as the thickness of the scintillator is reduced. If the size of the individual pixels is also reduced, spatial resolution is improved. As a result of this independence, there is a compromise between spatial resolution and contrast resolution when designing such a detector.

### SUMMARY AND DESCRIPTION

A problem emerges as a result of the use of light-sensitive semiconductor-sensors. The smaller the dimensions selected for the light-sensitive semiconductor-sensors, the more unfavorable the signal-noise ratio becomes. As a result, this further limits the achievable spatial resolution.

The present embodiments may obviate one or more of the drawbacks or limitations in the related art. For example, an effective method for spatially resolved detection of X-ray quants is provided.

The method may be used for the detection of X-ray quants that are generated in an X-ray tube and impact on a multi-pixel X-ray detector including a two-dimensional matrix of test-signal-generating pixels. To achieve this, the pixels that generate a test signal within a predetermined time interval and are located in a cohesive cluster including a plurality of pixels are assigned to an event cluster by an evaluation unit. The test signals from the pixels in such an event cluster are assessed by the evaluation unit as being correlated and are consequently used to approximate a position, at which the X-ray quant interacted with the multi-pixel X-ray detector. In this procedure, it is assumed that the impacting of an X-ray quant may influence a plurality of adjacent pixels, such that each pixel of the plurality of adjacent pixels generates a test signal. The test signals are subsequently used to estimate a location, at which the X-ray quant has impinged on the multi-pixel X-ray detector. The approximation is achieved, for example, with the aid of an appropriate algorithm. The test signals are therefore jointly subjected to a calculation procedure to determine the point of impact of an X-ray quant.

In one embodiment of the method, the multi-pixel X-ray detector includes a scintillator, an adjacent two-dimensional matrix of light-sensitive pixels to generate the test signals, and an evaluation unit to evaluate the test signals generated by the pixels. Each test signal represents a measure of the amount of light that led to the generation of the corresponding test signal. Additional information that may help to improve the effectiveness of the spatially resolved detection may thus be obtained.

In another embodiment of the method, a value lower than 1 μs is set for the time interval. The time interval helps avoid a plurality of X-ray quants contributing to the generation of a test signal, since an approximation becomes considerably more difficult in this case. If the time interval is selected to be as favorable as possible, two factors may be accommodated. As the intensity of the X-ray radiation increases, the size of the time interval may decrease as much as possible, since there is an increasing probability that a plurality of X-ray quants will impinge on the multi-pixel X-ray detector both close together and in close succession. A minimum size may be provided for the time interval in order to provide that the desired influencing of adjacent pixels by an X-ray quant is completely assimilated into the generation of the test signals and that the same test signals are also assessed by the evaluation unit as being correlated. Consideration may be given, for example, to reaction times, switching times or dead times for the electronics components used.

In one embodiment of the method, the approximation of the position, at which the X-ray quant has interacted with the multi-pixel X-ray detector, is achieved by defining a mathematical center of mass for a finite number of discrete mass points. This may involve carrying out a dedicated definition of the center of mass is for each event cluster. In this procedure, the relative position of the individual pixels with respect to one another constitutes the local distribution, and the test signals generated by the pixels constitute the mass distribution. Depending on the information content of the test signals, individual data items from the test signals may alternatively be used as the mass distribution (e.g., the measurement for the amount of light that has impacted on a light-sensitive pixel). By using such a method for the spatially resolved detection of X-ray quants, a resolution that is higher than the resolution of the pixel matrix used, which is limited by the pixel size, and hence higher than that of a multi-pixel X-ray detector according to the prior art may be provided. In one embodiment, as an alternative to the definition of the center of mass, a definition of the geometrical center is provided, for example.

According to another embodiment of the method, a maximum spatial event cluster size is set. The test signals from the pixels that generate a test signal within the time interval and that are located in an event cluster greater than the maximum spatial event cluster size are assessed by the evaluation unit as being erroneous test signals and are not evaluated. In this scenario, it is assumed that a plurality of X-ray quants have impinged on the multi-pixel X-ray detector close together within the time interval, with the result that the event clusters thereof are superimposed over one another. So that such events do not lead to a reduction in the spatial resolution, an approximation of two positions (e.g., two centers of mass) is carried out. In order to simplify the evaluation, however, the test signals that are generated in such an event may be, for example, ignored. As a result thereof, the spatial resolution remains unaffected, while the contrast resolution is reduced. The more improbable such an event, the less important is the reduction in the contrast.

In one embodiment of the method, a minimum spatial event cluster size is set. The test signals from the pixels that generate a test signal within the time interval and that are located in an event cluster smaller than the minimum spatial event cluster size are assessed by the evaluation unit as being erroneous test signals and are not evaluated. Such test signals are not generated by an X-ray quant, but are generated by effects such as pixel noise, for example.

In one embodiment of the method, the test signals from an event cluster that has a spatial event cluster size of between 2d and 6d (e.g., between 3d and 5d) are assessed as being non-erroneous test signals and evaluated. d is the pixel size that is provided by the diameter of the inner circle of the shape of a pixel. This takes into consideration the objective of designing the approximation to be as simple as possible.

In one embodiment, the pixels have a pixel size d smaller than 200 μm (e.g., smaller than 100 μm). Such a pixel size d makes may provide both a good local resolution and a completely adequate signal-noise-ratio.

In one embodiment of the method, the thickness of the scintillator is matched to the pixel size d such that when a point spread function (e.g., point response) is taken as a basis, at least 80% (e.g., at least 90%) of the amount of light generated by an X-ray quant impinges on a cluster of adjacent pixels with a size of at least 2d and at most 6d (e.g., between 3d and 5d). In one embodiment, the scintillator is provided by a Ti-doped CsI semi-conductor crystal. In this case, for example, a thickness of less than 2000 μm may be provided. The scintillator consequently may be designed to be considerably thicker than is the case with multi-pixel X-ray detectors according to the prior art (e.g., having a thickness less than 600 μm). The contrast resolution is significantly increased as a result of the increased thickness of the scintillator. According to the prior art, the thickness of the scintillator is selected such that, according to point spread function, around 90% of the amount of light that is generated by an X-ray quant impinges on one single pixel. With the present embodiments, the amount of light is distributed onto a plurality of pixels. The thickness of the scintillator may be greater than 100 μm (e.g., greater than 1500 μm).

In another embodiment of the method, the pixels are generated by active-pixel sensors (APSs) (e.g., CMOS sensors). Such sensors may be connected to appropriate readout electronics, such that a multi-pixel X-ray detector suitable for carrying out the present embodiments may be manufactured at a relatively low cost and production effort.

According to another embodiment, the pixels are arranged in the shape of a regular hexagon due to purely geometrical considerations. In a zone-covering matrix including pixels arranged in the shape of a regular hexagon, the expected event cluster shape closely approximates that of the rotation symmetry of the point spread function.

A detector suitable for carrying out the method described above is designed as a multi-pixel X-ray detector and includes a two-dimensional matrix of test-signal-generating pixels and an evaluation unit. The evaluation unit is configured to carry out the method according to the present embodiments.

### BRIEF DESCRIPTION OF THE DRAWINGS

FIG. 1 shows one embodiment of a multi-pixel X-ray detector and an evaluation unit;

FIG. 2 shows an exemplary point spread function in relation to the pixel size;

FIG. 3 shows an exemplary pixel matrix including square pixels;

FIG. 4 shows a diagrammatic view of exemplary event clusters;

FIG. 5 shows a diagrammatic view of an exemplary mass point distribution;

FIG. 6 shows an exemplary pixel matrix including hexagonal pixels; and

FIG. 7 shows a simplified block diagram of one embodiment of an X-ray unit.

### DETAILED DESCRIPTION OF THE DRAWINGS

Corresponding components are denoted by the same reference signs in the figures.

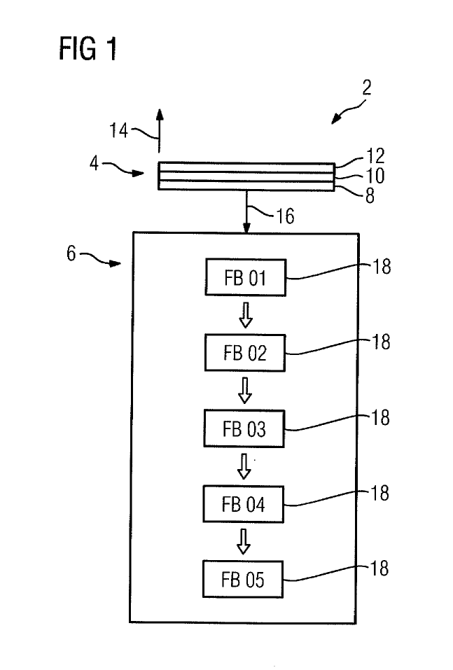

The method may be carried out with the aid of an apparatus 2, shown in FIG. 1, that includes a multi-pixel X-ray detector 4 and an evaluation unit 6 connected to the multi-pixel X-ray detector 4 by signal technology. In the embodiment according to FIG. 1, the multi-pixel X-ray detector 4 includes three layers and is configured as a digital X-ray detector. A first layer of the three layers functions as a base or circuit board component 8 and houses an electronics component that is not shown in further detail. Attached to the first layer is a second layer of the three layers. The second layer is formed of a two-dimensional matrix 10 of light-sensitive and test-signal-generating pixels P. The second layer is connected to the electronics component in the first layer by signal technology. A third layer of the three layers lies on top of the second layer and is configured as a scintillator 12. The scintillator 12 is provided, for example, by a Ti-doped CsI semi-conductor crystal.

If X-ray quants impinge on the scintillator 12, the X-ray quants interact with the semi-conductor crystal, in the process, generating photons with a wavelength in the range of visible light. The photons that spread out both counter to a layer sequence direction 14 and also transversely to the layer sequence direction 14 impinge successively on the pixels P in the two-dimensional matrix 10. Depending on the amount of impinging light, each pixel P generates an electrical test signal that is read off by the electronics component in the first layer and converted into a digital test signal. The electronics component further adds local information representing the relative position of the pixel P within the matrix 10 to the digital test signal pertaining to each pixel P. The test signals that have been supplemented in this manner are transmitted via an interface 16 to the evaluation unit 6, where the test signals are further processed with the aid of various functional components 18.

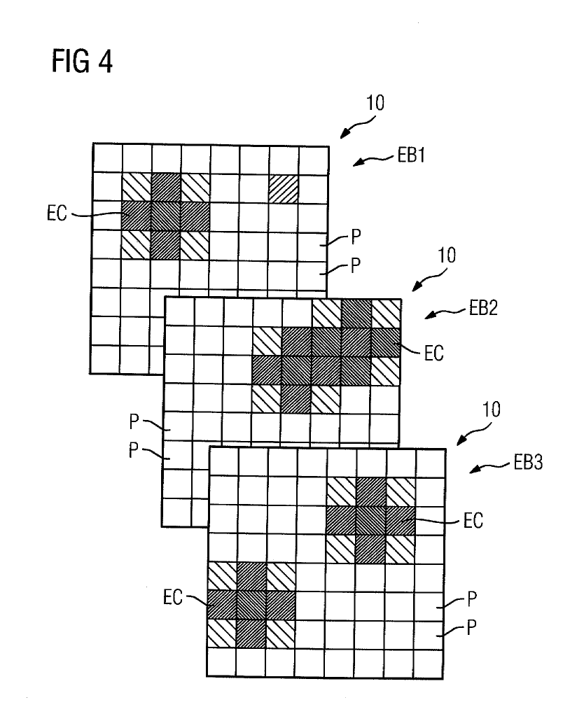

A first functional component FB 01 is used to determine the chronological coincidence. In the first functional component, test signals that have been generated within a predetermined time interval are combined and further transmitted as a data set to a second functional component FB 02. With the aid of the second functional component FB 02, a spatial coincidence is determined. Signals in the data set that have been generated by the pixels P that are located in a cluster of adjacent pixels P and thus form a cohesive area without any spaces between are assessed as being correlated and are assigned to an event cluster EC (see FIG. 4). In other words, it is assumed that an individual X-ray quant has led to the generation of these very same test signals.

The test signals assigned to an event cluster EC are subsequently transmitted to a third functional component FB 03 and are subjected to a discrimination process at the third functional component FB 03. The test signals pertaining to an event cluster EC, the spatial event cluster size of which is either greater than a predetermined maximum spatial event cluster size or smaller than a predetermined minimum spatial event cluster size, are assessed as being erroneous test signals and are not further evaluated.

Otherwise, information pertaining to an event cluster EC is used in a fourth functional component FB 04 to approximate a position, at which the X-ray quant that led to the formation of the event cluster EC interacted with the multi-pixel X-ray detector 4. The approximation may be achieved by defining a mathematical center of mass for a discrete distribution of mass points, the local distribution being given by a relative position of the individual pixels P within the matrix 10 and the mass being replaced by the test signal-related information that shows the amount of light that has impinged on the corresponding pixel P. The positions or the centers of mass for the event clusters EC obtained in this way are used in a fifth functional component FB 05 to generate a visual image that reflects the spatial distribution of the X-ray radiation that has been detected.

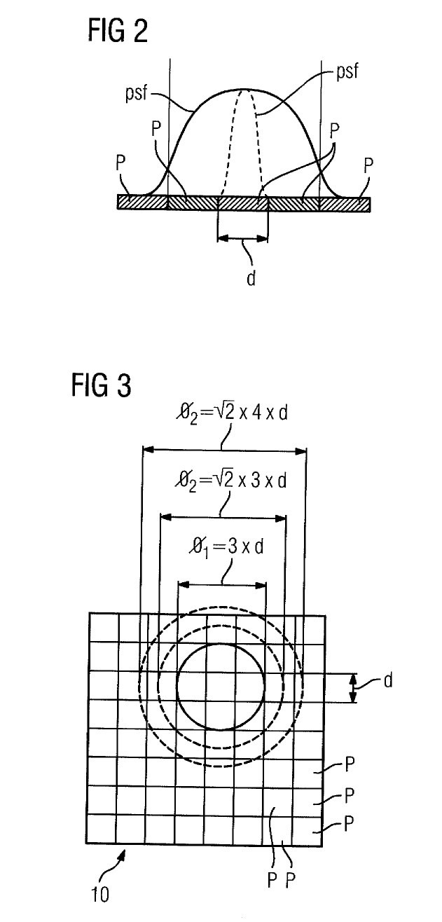

In order to adjust to the method, the third layer of the multi-pixel X-ray detector 4, which acts as a scintillator 12, has a substantially greater thickness than comparable X-ray detectors according to the prior art. This is the result of the different objectives that are set against one another in diagram form in FIG. 2. In X-ray detectors according to the prior art, the thickness of the layer is selected such that when a standardized point spread function (psf) is used as a basis, at least 90% of the amount of light generated by a single gamma quant impinges on an individual pixel. According to the present embodiments, the thickness of the layer is selected such that the amount of light is distributed more intensively to a plurality of pixels. In the embodiment, 90% of the amount of light impinges, for example, on a cluster of 3×3 pixels P.

The minimum and the maximum spatial event cluster size are adjusted to the selected layer thickness. As shown in FIG. 3, pixels P with a square basic shape are provided to form the matrix 10 of the multi-pixel detector 4. The diameter of the inner circle, which represents the pixel size d, corresponds to the edge length of a pixel. In the embodiment, an area with an inner circle diameter of 3d is set as the minimum spatial event cluster size, and a zone with an inner circle diameter of \sqrt{2}×4d is set as the maximum spatial event cluster size. Depending on the use in each case, alternative provision is made to reduce the maximum spatial event cluster size to a value of \sqrt{2}×3d.

By setting a minimum and a maximum event cluster size, the test signals are filtered such that, when given prerequisites are met, test signals are ignored or deleted and are consequently not completely evaluated. FIG. 4 shows a diagram of three possible events, by which the selection criteria may be reproduced in a simple manner. FIG. 4 shows the matrix 10 of individual square pixels P, some of the pixels P being shaded in, to symbolize that the respective pixel P has generated a test signal within the time interval. An intensity of the shading is a measure of the amount of light that has led to the generation of the test signal.

In a first event example EB 1, an individual shaded pixel P that is completely surrounded by pixels P that do not have any shading at all is shown. The test signal from this shaded pixel p is assessed as being erroneous since the condition of the minimum event cluster size has not been met. The cause of such a test signal may be pixel noise, for example. The cluster of shaded pixels P in event example 2 EB 2 does not meet the condition of the maximum event cluster size, which is why the test signals pertaining to the pixels in this cluster are likewise assessed as being erroneous and are not further evaluated. The assumption is that the cluster represents a spatial superimposition of two event clusters EC, as a result of which the test signals pertaining to the pixels P in this cluster are not suitable for a simple determination of the center of mass. Event example EB 3 shows two spatially separated clusters of shaded pixels P, the spatial event cluster size of which is in each case within the predetermined range, such that each of the two clusters is an event cluster EC that is suitable for an approximation. Therefore, the test signals pertaining to the pixels P for these two clusters are evaluated.

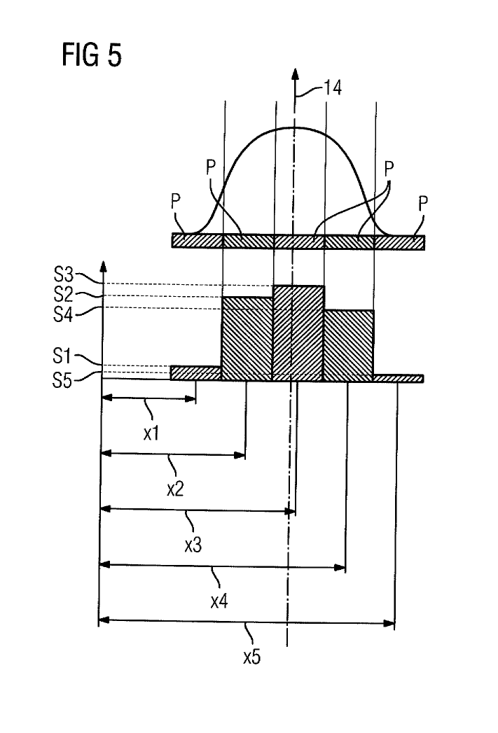

The algorithm to approximate the position, at which the X-ray quant has interacted with the multi-pixel X-ray detector 4, may be summarized as follows. In the direction of the sequence of the layers 14 above the matrix 10, an X-ray quant interacts with the scintillator 12, generating a number of photons in the process. The photons extend isotropically transverse to the direction of the sequence of the layers 14, as a result of which the distribution of the amount of light on the matrix 10 is similar to a bell curve. The peak of the bell curve is located at a point that may be depicted by projection in the direction of the sequence of the layers 14 onto the position, at which the X-ray quant has interacted with the CsI semi-conductor crystal. The pixels P, onto which some of the light impinges, generate a test signal that represents the amount of light that has led to the generation of the test signal. In the embodiment, a test signal is generated by a voltage S (e.g., representing the value for the amount of light). The corresponding voltage values, represented in FIG. 5, for example, by the values S₁ to S₅, replace the mass values in the determination of the center of mass with the result that the center of mass and thus the approximated position xₛ of the X-ray quant is given by:

$${X}_{S} = \frac{1}{{\sum }_{i = 1}^{S} {S}_{i}} {\sum }_{i = 1}^{S} {S}_{i} \times {X}_{i}$$

The values Xᵢ are the relative positions of the individual pixels P within the matrix 10. The procedure for the determination of the center of mass in a two-dimensional scenario is achieved by analogy with the above.

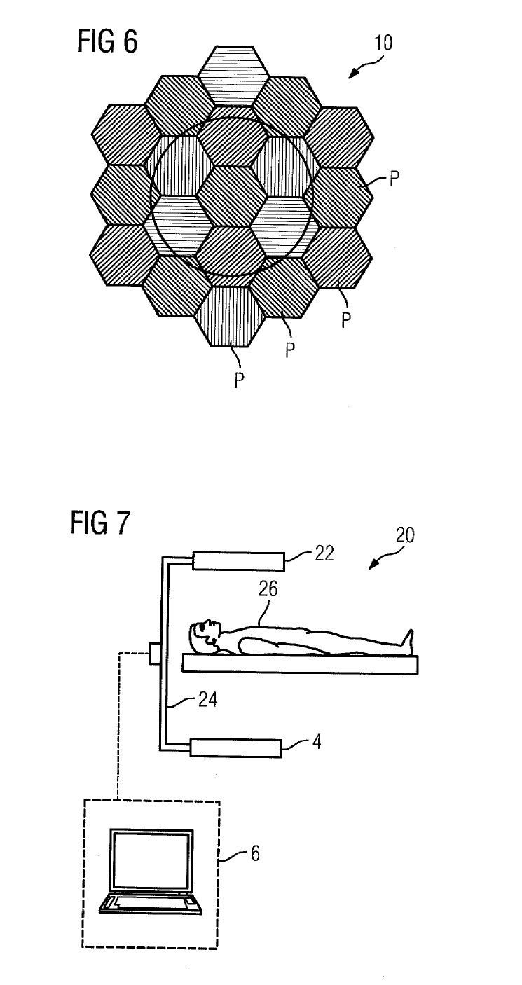

Adjusting to the rotation symmetry of the “point spread function,” in an alternative configuration of pixels P, the matrix 10 is formed in the shape of a regular hexagon. A design along these lines is partly shown in FIG. 6.

The described method is used, for example, in an X-ray unit 20, as shown in diagram form in FIG. 7. The X-ray unit 20 includes an X-ray tube 22, facing which the X-ray detector 4 is arranged. In the exemplary embodiment, the X-ray tube 22 and the X-ray detector 4 are directly connected to each other (e.g., by a C-arm). The X-ray unit 20 is used in the medical field, for example, for diagnostic purposes. A patient 26 (e.g., a subject to be irradiated) is irradiated for examination purposes. The X-ray beams that are transmitted are recorded by the X-ray detector 4, and the test signals are transmitted to the evaluation unit 6 in order to produce diagnostic images. The evaluation of the test signals transmitted by the X-ray detector 4 to the evaluation unit 6 may occur directly during the investigation or also at a later time.

All the individual features described with respect to the embodiments may also be combined in a different way without departing from the subject matter of the invention.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for the detection of X-ray quants that have been generated in an X-ray tube and impinge on a multi-pixel X-ray detector comprising a two-dimensional matrix of test-signal-generating pixels, the method comprising:
assigning, by an evaluation unit, pixels that generate a test signal within a predetermined time interval and are located in a cohesive cluster comprising a plurality of pixels to an event cluster; and
approximating a position, at which an X-ray quant has interacted with the multi-pixel X-ray detector using the test signals.

2. The method as claimed in claim 1, wherein the multi-pixel X-ray detector includes a scintillator, a two-dimensional matrix of light-sensitive pixels adjacent to the scintillator to generate the test signals, and the evaluation unit to evaluate the test signals generated by the pixels, and
wherein each of the test signals represents a measure of an amount of light that led to the generation of the corresponding test signal.

3. The method as claimed in claim 1, wherein the time interval is less than 1 μs.

4. The method as claimed in claim 1, wherein the test signals assigned to an event cluster are used in the evaluation unit to carry out a mathematical center of mass determination in order to approximate the position.

5. The method as claimed in claim 1, further comprising setting a maximum spatial event cluster size,
wherein test signals assigned from pixels greater than the maximum spatial event cluster size are assessed by the evaluation unit as being erroneous test signals and are not evaluated.

6. The method as claimed in claim 1, further comprising setting a minimum spatial event cluster size,
wherein test signals from pixels smaller than the minimum spatial event cluster size are assessed by the evaluation unit as being erroneous test signals and are not evaluated.

7. The method as claimed in claim 2, wherein, at a pixel size, only test signals assigned to an event cluster having a spatial event cluster size of between two times the pixel size and six times the pixel size are assessed as being non-erroneous test signals and evaluated.

8. The method as claimed in claim 1, wherein the pixels have a pixel size smaller than 200 μm.

9. The method as claimed in claim 7, wherein the thickness of the scintillator is adjusted to the pixel size such that when a point spread function is used as a basis, at least 80% of the amount of light generated by the X-ray quant impinges on the event cluster having a size that is between a minimum of two times the pixel size and a maximum of six times the pixel size

10. The method as claimed in claim 2, wherein the thickness of the scintillator is greater than 1000 μm.

11. The method as claimed in claim 1, wherein the pixels are generated by active-pixel sensors.

12. The method as claimed in claim 1, wherein the pixels have the shape of a regular hexagon.

13. The method as claimed in claim 7, wherein, only test signals assigned to an event cluster having a spatial event cluster size of between three times the pixel size and five times the pixel size are assessed as being non-erroneous test signals and evaluated.

14. The method as claimed in claim 8, wherein the pixel size is smaller than 100 μm.

15. The method as claimed in claim 9, wherein the thickness of the scintillator is adjusted to the pixel size such that when the point spread function is used as the basis, at least 90% of the amount of light generated by the X-ray quant impinges on the event cluster having a size that is between a minimum of three times the pixel size and a maximum of five times the pixel size.

16. The method as claimed in claim 2, wherein the thickness of the scintillator is greater than 1500 μm.

17. An apparatus for the detection of X-ray quants, the apparatus comprising:
a multi-pixel X-ray detector including a two-dimensional matrix of test-signal generating pixels; and
an evaluation unit,
wherein the evaluation unit is configured to:
assign pixels that generate a test signal within a predetermined time interval and are located in a cohesive cluster comprising a plurality of pixels to an event cluster; and
approximate a position, at which an X-ray quant has interacted with the multi-pixel X-ray detector using the test signals.

18. The method as claimed in claim 17, wherein the pixels have a pixel size smaller than 200 μm.

19. The method as claimed in claim 17, wherein the thickness of the scintillator is greater than 1000 μm.

20. The method as claimed in claim 17, wherein the pixels have the shape of a regular hexagon.
